(19) United States
(12) Patent Application Publication
(10) Pub. No.: US 2007/0175556 A1
(43) Pub. Date: Aug. 2, 2007

(54) Novel tire tread and process for creating footprints

(76) Inventor: Karen Brummer, Oakfield, TN (US)

Correspondence Address: David W. Barman, 1101 NE 176 Terrace, North Miami Beach, FL, 33162, US

(21) Appl. No.: 11/344,378

(22) Filed: Jan. 31, 2006

(51) Int. Cl. B60C 11/00

(52) U.S. Cl. 152/209.1; 152/523; D12/503

(57) ABSTRACT

A tire comprising a tread with a plurality of raised ornamentations and a method of producing tire tracks with a specific configuration has been disclosed and claimed.

### SUMMARY OF THE INVENTION

The present invention relates to tire treads and the processes the molding of treads with specific surface features. In particular, the present invention relates to tires that are molded and the processes for molding tires whose tread comprises indentations, channels or other recesses extending substantially transversely to the tread and which further comprise tread features that produce a desired tread print after the tire contacts a driven surface.

### BACKGROUND OF THE INVENTION

These particular forms of tread can be realized with various molding processes linked to various molding techniques. The tire of the present invention is not limited to any particular molding technique. When tire manufacture processes are implemented industrially, two major problems have to be overcome: on the one hand, to make the molding successful, i.e. to create without defect (visible or otherwise) a tire comprising desired feature in the tread; and, on the other hand, to permit ejection, i.e. separation, of the molded tire from the elements constituting the mold without the risk of damage either to the tire or to the tooling.

The PCT Patent application WO98/54009, incorporated herein by reference, describes one such a process and a mold for this process. The axial channels of the tread are molded by fingers integral with the shells provided for molding the sides of the tire. During molding, the internal pressure on the uncured (hence moldable) tire exerted by the membrane causes the outer diameter of the uncured tire to expand. This stage, known as “shaping,” allows the material forming the uncured tread to fill all the spaces in the mold to create the final tread comprising the various grooves and recesses which can be seen to open at the running surface or at the shoulders. In order to remove the tire from the mold, the shells are removed axially, which allows the fingers to be extracted from the tread. The segments of the crown ring, which mold the running surface, are removed radially in order to allow their projecting parts (the projections which mold the sculpturing) to disengage from the tread of the molded tire.

Another known process (described for example in U.S. Pat. No. 1,733,064) consists in inserting fingers or pins axially into the uncured rubber of the tread. This method then encounters other limitations: the geometry and resistance of the fingers or pins must permit their penetration without risking damage to the tool but also without moving or deforming the uncured tire in an unwanted manner. In practice, this technique is therefore restricted to fingers having a simple geometry and sufficient thickness to resist buckling. On the other hand, the kinematics necessary to control the movements of these fingers also imposes a considerable restriction on the possible forms.

Still another process is described in U.S. Pat. No. 6,767,495, incorporated herein by reference, whereby the limitations of the prior art are addressed and improved upon with a process and mold for producing tires. This patent comprises a mold for a tire tread having a running surface, lateral surfaces, radial recesses opening at the running surface and axial recesses opening on to at least one of the lateral surfaces, the mold comprising a first plurality of crown sectors for molding the radial recesses, a second plurality of shoulder sectors, among which at least some carry projections for molding the axial recesses, the crown sectors being radially movable between an open configuration permitting loading of uncured tire into the mold and a closed configuration permitting molding of the tire, the mold being characterized in that the shoulder sectors are radially movable between the open configuration and the closed configuration independently of the crown sectors.

Processes known by those skilled in the art may manufacture the tire of the subject invention. One possible process uses a mold and comprises successively the following steps:

Inserting an uncured tire into a mold which comprises an inner surface having recessed portions in the shape of a desired footprint;

Closing the mold by centripetal motion of the crown sectors and shoulder sectors;

Molding the tire;

Opening the mold by radial motion of the crown sectors in order to eject the radial recesses, the shoulder sectors remaining substantially in a closed configuration; and,

Continuing opening of the mold by axial motion of the shoulder sectors; ejecting a tire with the desired footprint.

In one embodiment, the diameter of the uncured tire is less than the diameter of the molded tire by a value “d,” which is less than 1% of the diameter of the molded tire.

It is generally known in the art how to form the tread configuration of a tire. It has not been known how to further incorporate into the tread, a desired configuration whereby the resultant tire track creates an imprint that has additional significance.

It is an object of the present invention to provide a tire with a tread that comprises a plurality of ornamentations such that the tire track creates an imprint that has additional significance.

It is another object of the present invention to provide a tire with a tread wherein said ornamentations create an imprint that is a logo or footprint.

It is another object of the present invention to provide a method for creating a tire track using a tire with a tread that comprises a plurality of ornamentations.

### BRIEF DESCRIPTION OF THE DRAWINGS

FIGS. 1 and 2 show offset and side views of a tire of the invention with deer tracks.

FIGS. 3 and 4 show offset and side views of a tire of the invention with bear tracks.

FIGS. 5 and 6 show offset and side views of a tire of the invention with duck tracks.

FIGS. 7 and 8 show offset and side views of a tire of the invention with turkey tracks.

FIGS. 9 and 10 show offset and side views of a tire of the invention with the University of Tennessee logo.

### DETAILED DESCRIPTION

The present invention is a tire that will produce a desired custom tire track when the vehicle on which said tire is installed, is moved over a surface. In one embodiment, the tire of the present invention comprises:
(a) An outer surface comprising a tread with a plurality of raised ornamentations;
(b) An outer sidewall with raised surface ornamentation related to said tread ornamentations;
   The plurality of raised ornamentations on said tread may be an animal footprint a commercial logos, or any other ornamentation that is desired by the user. Some examples of ornamentations include, but are not limited to college logos, sports logos, company logos, animal tacks and the like. For example, a hunting enthusiast may choose bear, deer, duck, turkey or any other animal track ornamentation that would create the animal track on the surface when the tire is moved over a surface while attached to a vehicle. In one embodiment, the tire further comprises an ornamental sidewall. The ornamental sidewall may be a flat or raised ornamental surface. The ornamental surface may comprises words or pictures related to said ornamentation on said tread.

In one embodiment, the ornamental sidewall comprises words and pictures related said ornamentation on said tread. For example, a tire with bear tracks on the tread may further comprise bear tracks on the sidewall and may further comprise other words, phrases or pictures relating to bear hunting. This may include pictures of bears, bear tracks, bear traps, guns, or phrases such as “Bear Hunter” and the like. The term “tire” as used herein refers to any type of tire that is used on any type of vehicle. A preferred embodiment provides for a pneumatic tire on a motor vehicle.

The subject invention also provides for a process for creating a custom tire track with a tire tread comprising the steps of:
(a) Installing tires with an ornamental tread onto a vehicle;
(b) Moving said vehicle over a surface, wherein said footprints of said tires create tracks on said porous surface.

The surface may be a hard or porous surface. A porous surface may be an unpaved road, trail, sand, and the like. An alternative embodiment provides for a process for creating a design with a tire tread comprising the steps of:
(a) Installing tires comprising a tread with a plurality of raised ornamentations onto a vehicle;
(b) Activating a liquid dispersion source whereby said liquid dispersion source deposits liquid onto the tread of the tire and whereby said tire treads are wet with a liquid;
(c) Moving said vehicle over a surface whereby said liquid that has been dispersed on said tires create a footprint.

The liquid source in one embodiment may be water. Alternatively the liquid applied to the tire may be another organic, inorganic, or cosolvent mixture that is desired to produce the custom tire tracks.

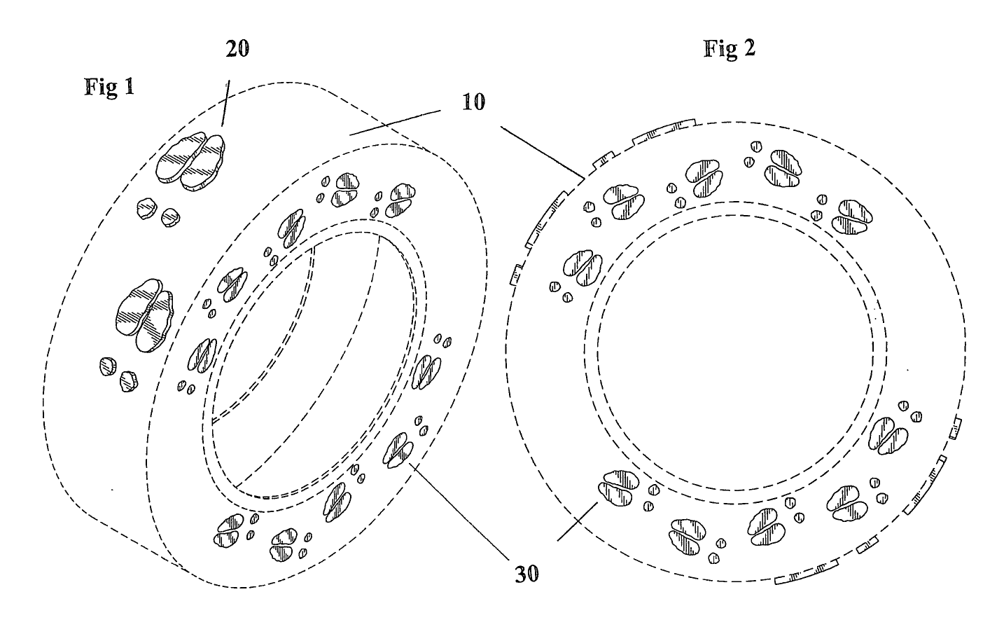

In FIG. 1, shows a tire according to the invention in an offset view. The tire 10 has deer footprints 20 which extend from the outer tread. This particular embodiment further has deer footprints 30 on sidewall.

FIG. 2 shows a side view of tire 10 with deer footprints 30 on the sidewall.

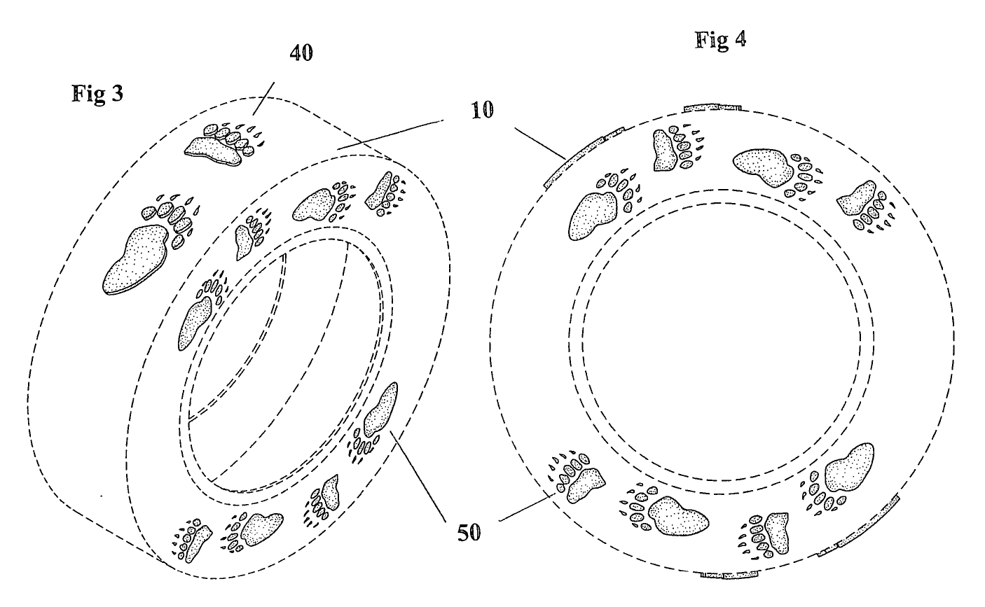

FIG. 3 shows a tire according to the invention in an offset view. The tire 10 has bear footprints 40 which extend from the outer tread. This particular embodiment further has bear footprints 50 on sidewall.

FIG. 4 shows a side view of tire 10 with bear footprints 50 on the sidewall.

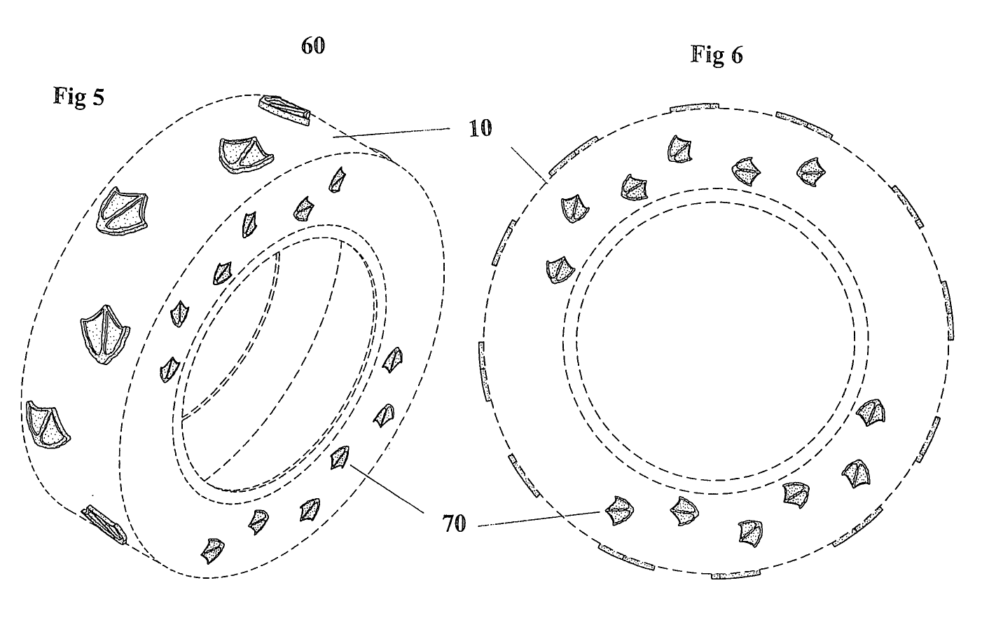

FIG. 5 shows a tire according to the invention in an offset view. The tire 10 has duck footprints 60 which extend from the outer tread. This particular embodiment further has duck footprints 70 on sidewall.

FIG. 6 shows a side view of tire 10 with duck footprints 70 on the sidewall.

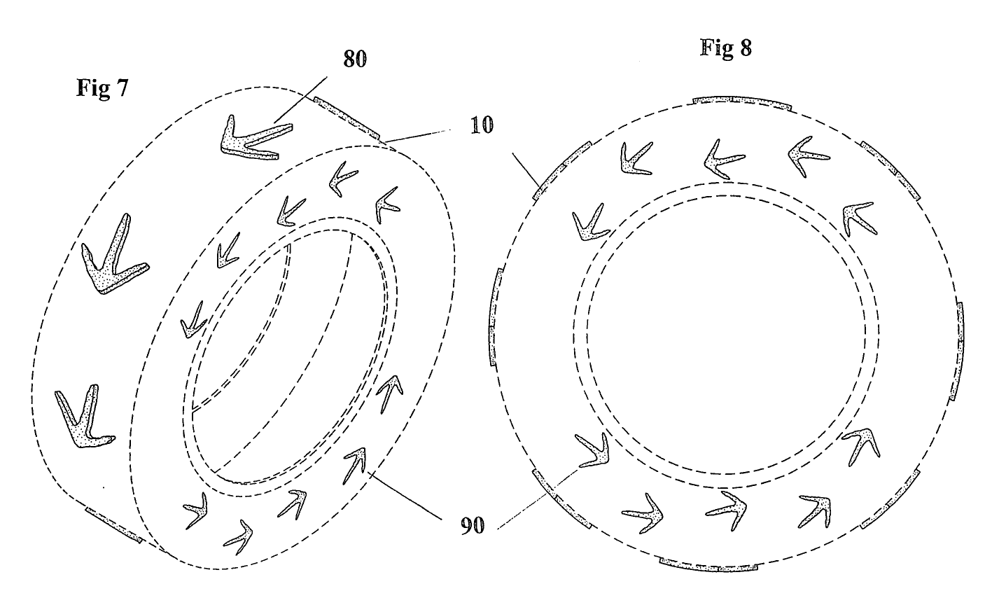

FIG. 7 shows a tire according to the invention in an offset view. The tire 10 has turkey footprints 80 which extend from the outer tread. This particular embodiment further has turkey footprints 90 on sidewall.

FIG. 8 shows a side view of tire 10 with turkey footprints 90 on the sidewall.

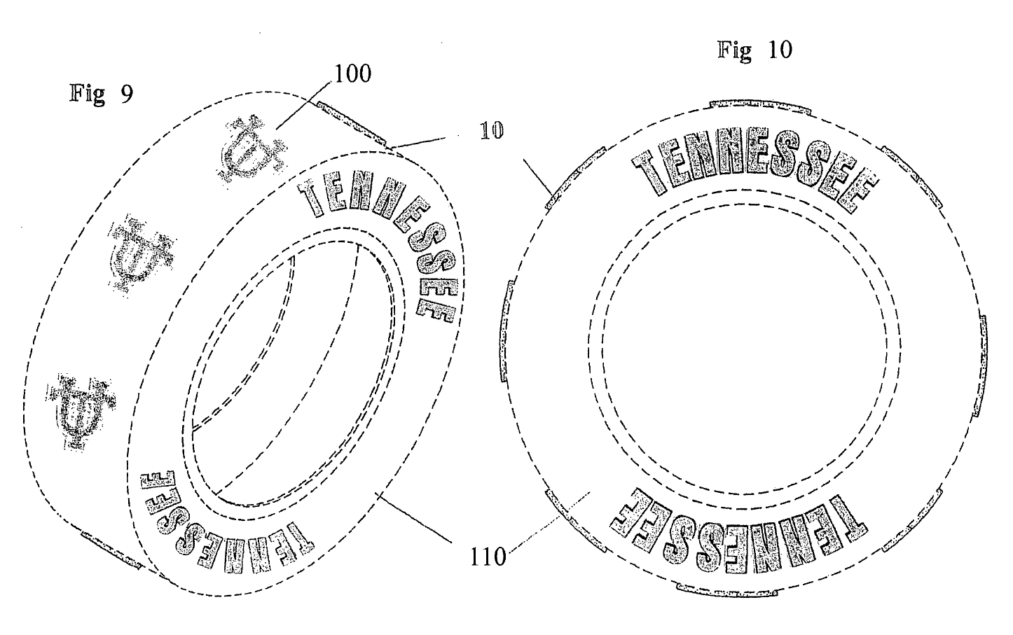

FIG. 9 shows a tire according to the invention in an offset view. The tire 10 has the University of Tennessee logo 100 which extend from the outer tread. This particular embodiment further has “Tennessee” 110 on sidewall.

The examples shown in the figures are only meant to be illustrative and are not intended to limit the scope of the invention. Every logo of all schools, sports teams, corporations, and the like may be used in the present invention. Alternatively, although the illustrations provide for the footprints of hunting animals, the custom tire track may include the footprints of any animal, including humans, in order to produce the custom tire track envisioned in the present invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed is:

1. A tire comprising:
(a) An outer surface comprising a tread with a plurality of raised ornamentations;
(b) An outer sidewall with raised surface ornamentation related to said tread ornamentations.

2. The tire of claim 1 wherein said plurality of raised ornamentations on said tread is selected from the group consisting of footprints and logos.

3. The tire of claim 2 wherein said footprint is selected from the group consisting of bear, deer, duck, and turkey.

4. The tire of claim 1 wherein said raised surface of said sidewall comprises identical ornamentations to said tread.

5. The tire of claim 1 wherein said raised surface of said sidewall comprises words or pictures related to said ornamentation on said tread.

6. The tire of claim 1 wherein said raised surface of said sidewall comprises words and pictures related said ornamentation on said tread.

7. The tire of claim 1 wherein said tire is a pneumatic tire.

8. A process for creating a design with a tire tread comprising the steps of:
(a) Installing tires of claim 1 onto a vehicle;
(b) Moving said vehicle over a surface, wherein said footprints of said tires create tracks on said surface.

9. A process for creating a design with a tire tread comprising the steps of:
(a) Installing tires of claim 1 onto a vehicle;
(b) Activating a liquid dispersion source whereby said tires are wet with a liquid;
(c) Moving said vehicle over a surface whereby said liquid that has been dispersed on said tires create a footprint.

10. The process of claim 8 wherein said plurality of raised ornamentations on said tire tread is a logo or footprint.

11. The process of claim 10 wherein said plurality of raised ornamentations on said tire tread is an animal footprint.

12. The process of claim 10 wherein said plurality of raised ornamentations on said tire tread is a deer, bear, duck or turkey footprint.
